(19) United States
(12) Patent Application Publication
(10) Pub. No.: US 2008/0267257 A1
(43) Pub. Date: Oct. 30, 2008

(54) Method and System for Detecting Substrate Temperature in a Track Lithography Tool

(75) Inventor: Harald Herchen, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SOKUDO CO., LTD., Shimogyo-ku (JP)

(21) Appl. No.: 11/741,121

(22) Filed: Apr. 27, 2007

(51) Int. Cl. G01K 11/20; F24J 3/00

(52) U.S. Cl. 374/161; 432/227

(57) ABSTRACT

A device for measuring a temperature of a semiconductor wafer comprises a structure adapted to support the semiconductor wafer. The structure has an upper end and a lower end. The upper end contacts the wafer. A photoluminescent material is adapted to emit an emission light energy in response to the temperature of the wafer. A light source is adapted to emit an excitation light energy. The light source is optically coupled to the photoluminescent material. A detector is adapted to measure the emission light energy emitted from the photoluminescent material so as to determine the temperature of the wafer. In specific embodiments, the photoluminescent material may be positioned near the upper end of the structure to measure the temperature of the wafer while the wafer is supported with the structure. The structure may comprise a proximity pin and an optically transparent material. The light source and the detector may be positioned near the lower end of the structure and optically coupled to the photoluminescent material.

### BACKGROUND OF THE INVENTION

The present invention relates generally to the field of substrate processing equipment. More particularly, the present invention relates to a method, apparatus and devices for measuring thermal characteristics of a semiconductor wafer in a processing apparatus. Merely by way of example, the method and apparatus of the present invention are used to measure temperatures in a track lithography tool. The method and apparatus can be applied to other processes for semiconductor substrates including other processing chambers.

Modern integrated circuits contain millions of individual elements that are formed by patterning the materials, such as silicon, metal and dielectric layers, that make up the integrated circuit to sizes that are small fractions of a micrometer. The technique used throughout the industry for forming such patterns is photolithography. A typical photolithography process sequence generally includes depositing one or more uniform photoresist (resist) layers on the surface of a substrate, drying and curing the deposited layers, patterning the substrate by exposing the photoresist layer to radiation that is suitable for modifying the exposed layer and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various stations of the track tool and an interface that allows the tool to be operatively coupled to a lithography exposure tool in order to transfer substrates into the exposure tool and to receive substrates after they have been processed within the exposure tool.

Over the years there has been a strong push within the semiconductor industry to shrink the size of semiconductor devices. The reduced feature sizes have caused the industry's tolerance to process variability to shrink, which in turn, has resulted in semiconductor manufacturing specifications having more stringent requirements for process uniformity and repeatability. An important factor in minimizing process variability during track lithography processing sequences is to ensure that every substrate processed within the track lithography tool for a particular application has the same “wafer history.” A substrate's wafer history is generally monitored and controlled by process engineers to ensure that all of the device fabrication processing variables that may later affect a device's performance are controlled, so that all substrates in the same batch are always processed the same way.

To ensure that each substrate has the same “wafer history” requires that each substrate experiences the same repeatable substrate processing steps (e.g., consistent coating process, consistent hard bake process, consistent chill process, etc.) and the timing between the various processing steps is the same for each substrate. Lithography type device fabrication processes can be especially sensitive to variations in process recipe variables and the timing between the recipe steps, which directly affects process variability and ultimately device performance. Generally, characterization of processing operations is performed to determine the thermal properties of processing apparatus as a function of time.

Work in relation with the present invention suggests that current techniques used to determine temperatures may be somewhat indirect and less than ideal. For example, techniques that measure temperatures only at selected locations near the wafer may not measure temperatures at many locations near the wafer that can effect the wafer processing history. Although substrate supports made of highly heat conductive metals such as Aluminum may be used to spread heat from a source to provide uniform heating of the wafer, some non-uniformity in heat applied to the wafer can persist, and thermal measurements from such substrate supports can be somewhat indirect.

In view of these requirements and shortcomings, the semiconductor industry is continuously researching methods and developing tools and techniques to improve the thermal measurement capabilities associated with track lithography and other types of cluster tools.

### SUMMARY OF THE INVENTION

According to the present invention, techniques related to the field of semiconductor processing equipment are provided. More particularly, the present invention relates to a method and apparatus for measuring thermal characteristics of a semiconductor wafer in a processing apparatus. Merely by way of example, the method and apparatus of the present invention are used to measure temperatures in a track lithography tool. The method and apparatus can be applied to other processes for semiconductor substrates including other processing chambers.

In many embodiments, a device for measuring a temperature of a semiconductor wafer is provided. The apparatus comprises a structure to support the semiconductor wafer. The structure comprises an upper end and a lower end. The upper end of the structure is adapted to contact the wafer. A photoluminescent material is adapted to emit an emission light energy in response to the temperature of the wafer. A light source is adapted to emit an excitation light energy. The light source is optically coupled to the photoluminescent material. A detector is adapted to measure the emission light energy emitted from the photoluminescent material to determine the temperature of the wafer while the wafer is supported with the structure.

In specific embodiments, the photoluminescent material may be positioned near the upper end of the structure to measure the temperature of the wafer while the wafer is supported by the structure. The structure may comprise a proximity pin and an optically transparent material. The light source and the detector may be positioned near the lower end of the structure and optically coupled to the photoluminescent material.

Many benefits are achieved by way of the present invention over conventional techniques. For example, embodiments of the present invention provide temperature measurements of semiconductor wafers and bakeplates with improved reliability, repeatability and accuracy. Additionally, embodiments of the present invention provide for improved wafer processing history, in particular repeatable heating of semiconductor wafers with bake plates. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified plan view of a track lithography tool according to embodiments of the present invention;

FIG. 2 is a simplified perspective view of a thermal unit according to embodiments of the present invention;

FIG. 3 is a simplified perspective view of the integrated thermal unit depicted in FIG. 2 with the top of the unit removed, according to embodiments of the present invention;

FIG. 4 is a perspective view of the bake station as shown in FIG. 3, according to embodiments of the present invention;

FIG. 5 is a perspective view of a cross-section of the bake station as shown in FIG. 4, according to embodiments of the present invention;

FIG. 6 is a cross-sectional view of bake station as shown in FIG. 5, according embodiments of the present invention;

FIG. 7A shows a simplified cross sectional view of a bake plate comprising a substrate support layer and several temperature sensing proximity pins that support a semiconductor wafer, according to embodiments of the present invention;

FIG. 7B shows temperature sensing proximity pins as in FIG. 7A in greater detail, according to embodiments of the present invention;

FIG. 7C shows a bake plate comprising a spherical temperature sensing proximity pin, according to embodiments of the present invention;

FIG. 7D shows a bake plate comprising a temperature sensing proximity pin that passes at least partially through an opening formed in the support layer, according to embodiments of the present invention;

FIG. 8A shows a waveguide that can be used to position a photoluminescent material near a wafer to measure the temperature of the wafer, according to embodiments of the present invention;

FIG. 8B shows lifetimes of photoluminescent materials that comprise phosphorescent materials, according to embodiments of the present invention;

FIG. 9 shows a bake plate comprising several temperature sensing proximity pins to map the temperature of the wafer, according to embodiments of the present invention; and

FIG. 10 shows a method of measuring a temperature of a semiconductor wafer, according to embodiments of the present invention.

### DETAILED DESCRIPTION OF THE INVENTION

According to the present invention, techniques related to the field of semiconductor processing equipment are provided. More particularly, the present invention relates to a method and apparatus for measuring thermal characteristics of semiconductor processing apparatus. Merely by way of example, the method and apparatus of the present invention are used to measure temperatures in a track lithography tool. The method and apparatus can be applied to other processes for semiconductor substrates including other processing chambers.

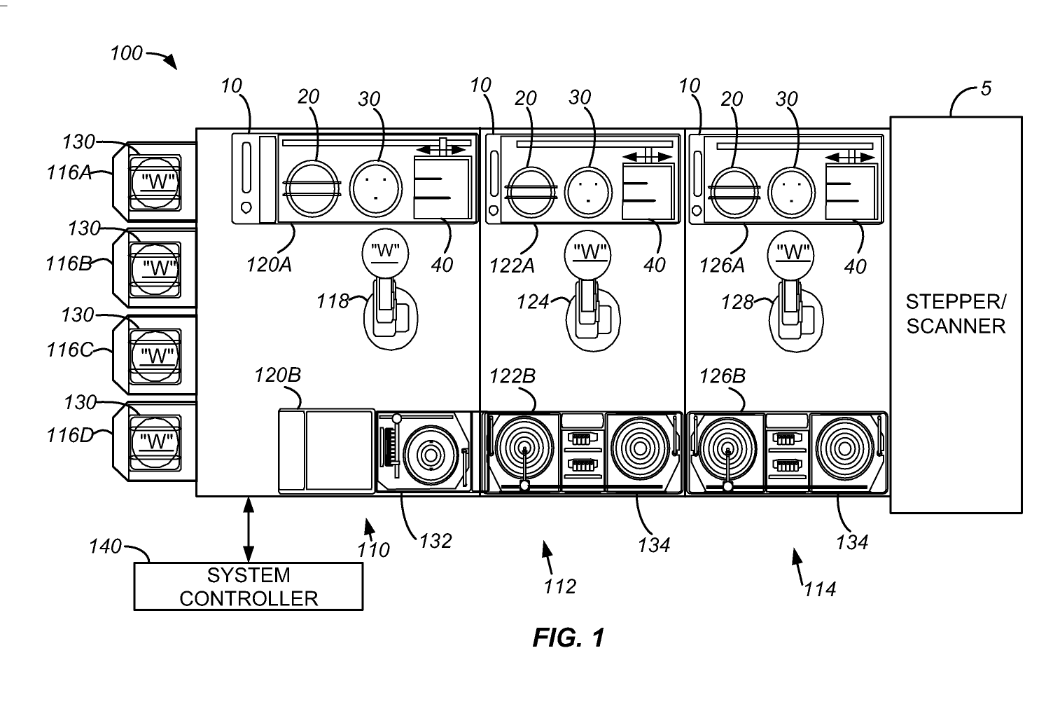

FIG. 1 is a plan view of one embodiment of a track lithography tool 100 in which the embodiments of the present invention may be used. As illustrated in FIG. 1, a cluster tool, for example track lithography tool 100, contains a front end module 110 (sometimes referred to as a factory interface), a central module 112, and a rear module 114 (sometimes referred to as a scanner interface). Front end module 110 generally contains one or more pod assemblies or FOUPS (e.g., items 116A-D), a front end robot 118, and front end processing racks 120A and 120B. The one or more pod assemblies 116A-D are generally adapted to accept one or more cassettes 130 that may contain one or more substrates, for example semiconductor material sliced to form thin semiconductor wafer substrates “W”, that are to be processed in track lithography tool 100.

Central module 112 generally contains a first central processing rack 122A, a second central processing rack 122B, and a central robot 124. Rear module 114 generally contains first and second rear processing racks 126A and 126B and a back end robot 128. Front end robot 118 is adapted to access processing modules in front end processing racks 120A and 120B; central robot 124 is adapted to access processing modules in front end processing racks 120A and 120B, central processing racks 122A and 122B and/or rear processing racks 126A and 126B; and back end robot 128 is adapted to access processing modules in the rear processing racks 126A and 126B and in some cases exchange substrates with a stepper/scanner 5.

The stepper/scanner 5, which may be purchased from Canon USA, Inc. of San Jose, Calif., Nikon Precision Inc. of Belmont, Calif., or ASML US, Inc. of Tempe Ariz., is a lithographic projection apparatus used, for example, in the manufacture of integrated circuits (ICs). The stepper/scanner 5 exposes a photosensitive material (resist), deposited on the substrate in the cluster tool, to some form of electromagnetic radiation to generate a circuit pattern corresponding to an individual layer of the integrated circuit (IC) device to be formed on the substrate surface.

Each of the processing racks 120A and 120B; 122A and 122B; and 126A and 126B contain multiple processing modules in a vertically stacked arrangement. That is, each of the processing racks may contain multiple stacked integrated thermal units 10, multiple stacked coater modules 132, multiple stacked coater/developer modules 134 with shared dispense, or other modules that are adapted to perform the various processing steps required of a track photolithography tool. As examples, coater modules 132 may deposit a bottom antireflective coating (BARC), coater/developer modules 134 may be used to deposit and/or develop photoresist layers, and integrated thermal units 10 may perform bake and chill operations associated with hardening BARC and/or photoresist layers.

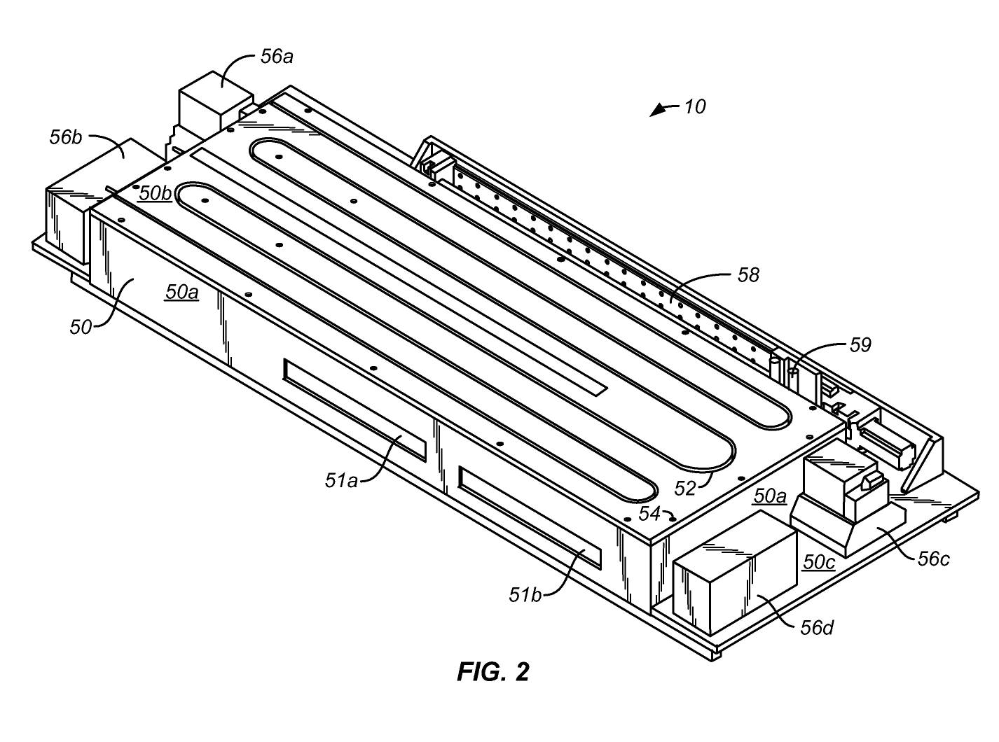

In one embodiment, a system controller 140 is used to control all of the components and processes performed in the track lithography tool 100. The controller 140 is generally adapted to communicate with the stepper/scanner 5, monitor and control aspects of the processes performed in the track lithography tool 100, and is adapted to control all aspects of the complete substrate processing sequence. In some instances, controller 140 works in conjunction with other controllers, such as controllers of control circuitry 56a-56d in FIG. 2, which control bake plate 22 and chill plate 30 of integrated thermal unit 10 to control certain aspects of the processing sequence. The controller 140, which is typically a microprocessor-based controller, is configured to receive inputs from a user and/or various sensors in one of the processing chambers and appropriately control the processing chamber components in accordance with the various inputs and software instructions retained in the controller's memory. The controller 140 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by the controller 140 determines which tasks are performable in the processing chamber(s). Preferably, the program is software readable by the controller 140 and includes instructions to monitor and control the process based on defined rules and input data.

It is to be understood that embodiments of the invention are not limited to use with a track lithography tool such as that depicted in FIG. 1. Instead, embodiments of the invention may be used in any substrate processing tool including the many different tool configurations described in U.S. application Ser. No. 11/112,281, filed on Apr. 22, 2005, entitled “Cluster Tool Architecture for Processing a Substrate,” which is hereby incorporated by reference for all purposes, and other configurations not described in the Ser. No. 11/112,281 application.

As shown in FIG. 2, which is a simplified perspective view of integrated thermal unit 10 depicted in FIG. 1, thermal unit 10 includes an exterior housing 50 made of aluminum or another suitable material. Housing 50 is long relative to its height in order to allow bake station 20, chill plate 30 and shuttle 40 (shown in FIG. 1) to be laterally adjacent to each other and to allow multiple integrated thermal units to be stacked on top of each other in a track lithography tool as described above with respect to FIG. 1. In one particular embodiment, housing 50 is just 20 centimeters high.

Housing 50 includes side pieces, a top piece 50b and a bottom piece 50c. Front side piece 50a includes two elongated openings 51a and 51b that allow substrates to be transferred into and out of the thermal unit. Opening 51a is operatively coupled to be closed and sealed by a shutter (not shown), and opening 51b is also operatively coupled to be closed and sealed by a shutter (also not shown). Top piece 50b of housing 50 includes coolant channels 52 that allow a coolant fluid to be circulated through the channels in order to control the temperature of top piece 50b when an appropriate plate (not shown) is attached to top piece 50b via screw holes 54. Similar coolant channels are formed in the lower surface of bottom piece 50c.

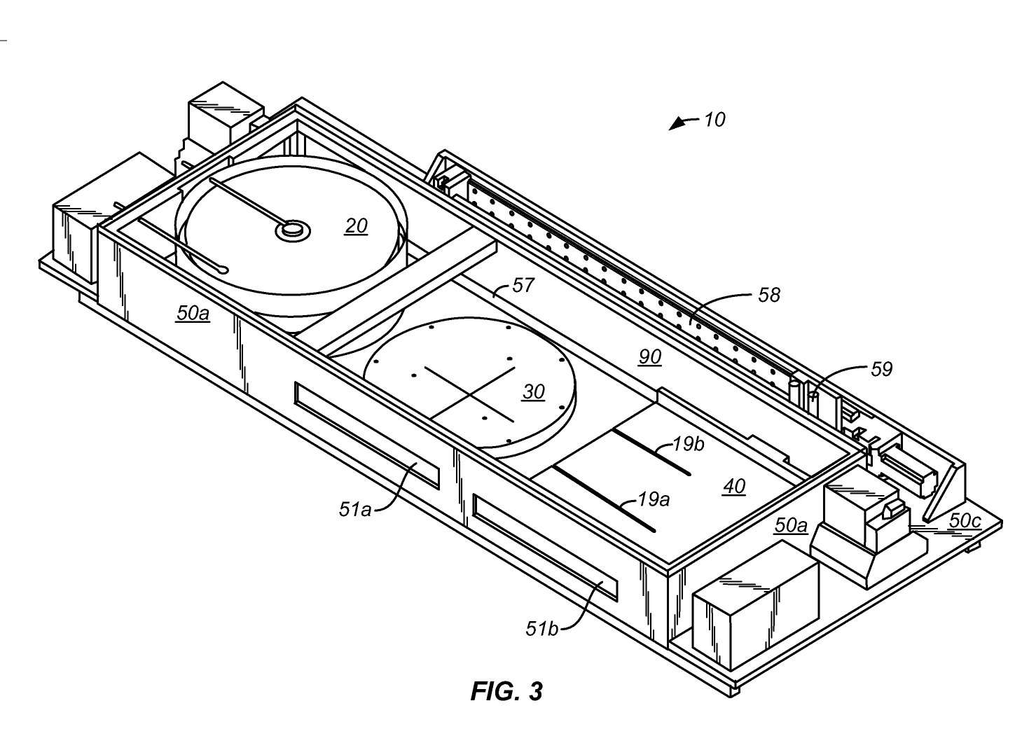

Also shown in FIG. 2 is various control circuitry 56a-56d which controls the precision baking operation of bake station 20 and the precision cooling operation of chill plate 30; and tracks 58 and 59 that enable shuttle 40 (shown in FIG. 3) to move linearly along the length of the thermal unit and vertically within the thermal unit. In one embodiment, control circuitry 56a-56b is positioned near bake station 20 and chill plate 30 in order to enable more accurate and responsive control of temperature adjusting mechanisms associated with each station.

FIG. 3 is a simplified perspective view of integrated thermal unit 10 as seen with top piece 50b removed. In FIG. 3, shuttle 40, chill plate 30 and bake station 20 are visible. Also visible is a space 57 between rear support piece 90 of housing 50 and bottom piece 50c. Space 57 extends along much of the length of integrated thermal unit 10 to allow shuttle 40 to transfer wafers between bake station 20 and chill plate 30.

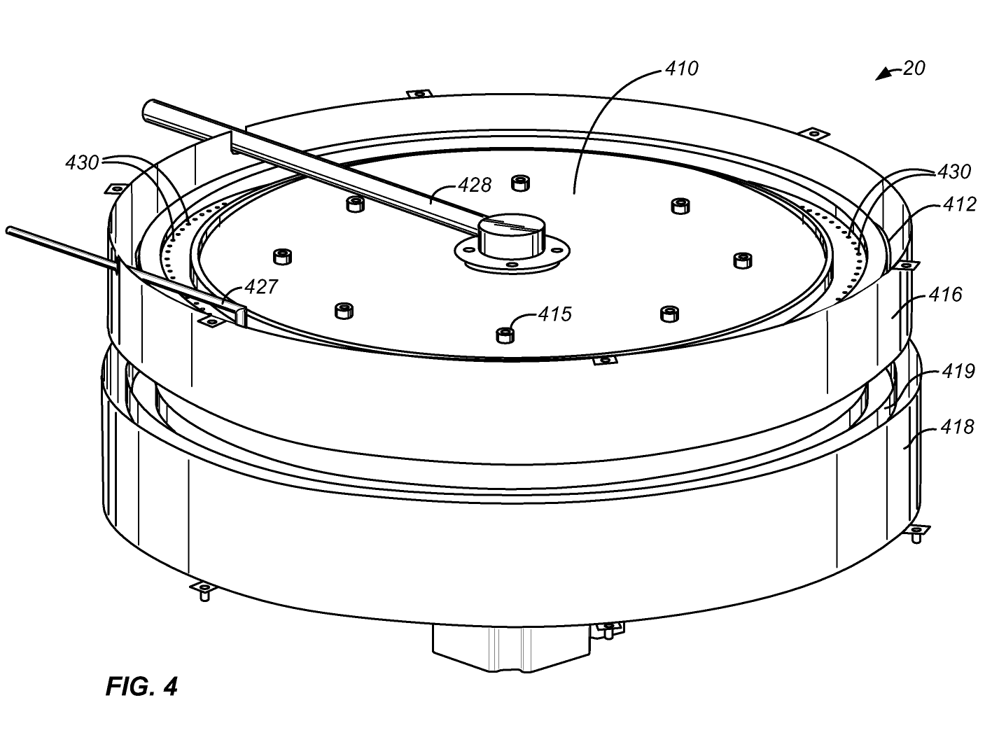

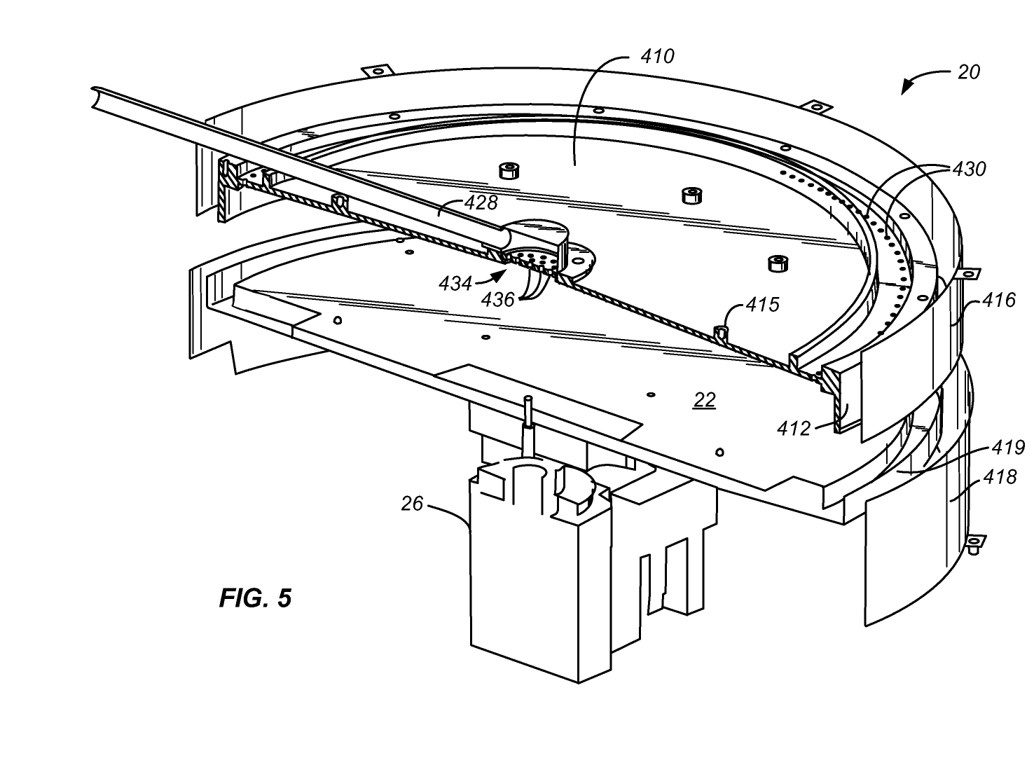

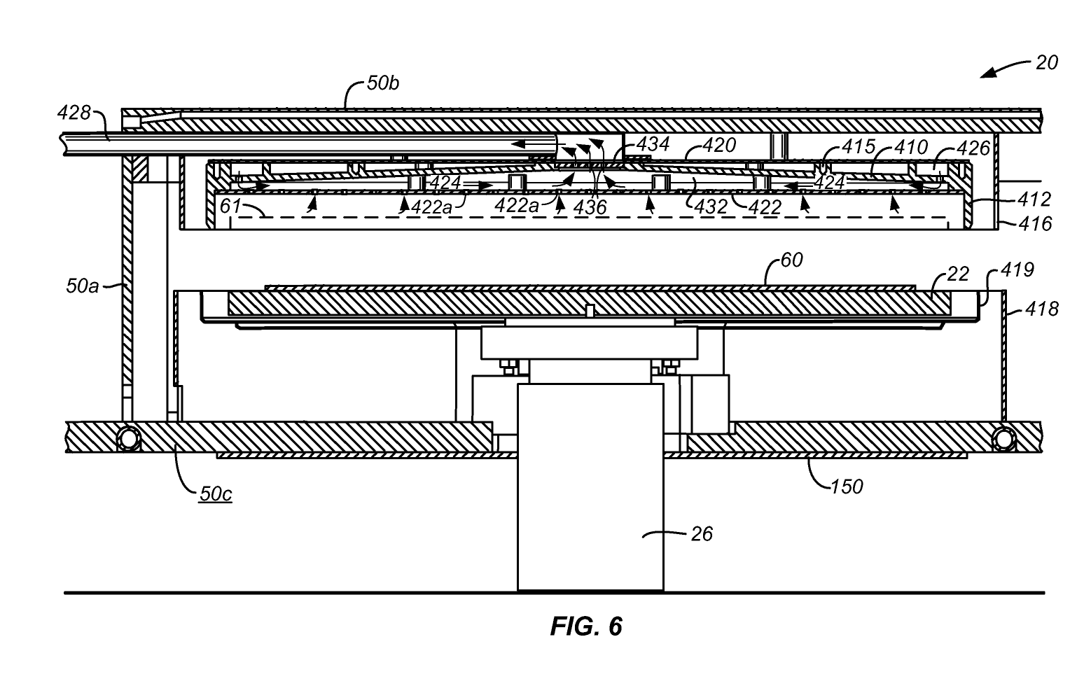

FIG. 4 is a perspective view of bake station 20 shown in FIG. 3 according to one embodiment; FIG. 5 is a perspective view of a cross-section of bake station 20 shown FIG. 4, and FIG. 6 is a cross-sectional view of the bake station 20. As shown in FIGS. 4-6, bake station 20 has three separate isothermal heating elements: bake plate 22, top heat plate 410 and side heat plate 412, each of which is manufactured from a material exhibiting high heat conductivity, such as aluminum or other appropriate material. Each plate 22, 410, and 412 has a heating element, for example resistive heating elements, embedded within the plate. Bake station 20 also includes side, top and bottom heat shields 416 and 418, respectively, as well as a bottom cup 419 that surrounds bake plate 22 and a lid 420 (shown in FIG. 6 only). Each of heat shields 416, 418, cup 419 and lid 420 are made from aluminum. Lid 420 is attached to top heat plate 410 by eight screws through threaded holes 415.

Bake plate 22 is operatively coupled to a motorized lift 26 so that the bake plate can be raised into the clam shell enclosure and lowered into a wafer receiving position. Typically, wafers are heated on bake plate 22 when it is raised to a baking position 61 as shown in FIG. 6. When in baking position 61, cup 419 encircles a bottom portion of side heat plate 412 forming a clam shell arrangement that helps confine heat generated by bake plate 22 within an inner cavity formed by the bake plate and the enclosure. In one embodiment the upper surface of bake plate 22 includes 8 wafer pocket buttons and 17 proximity pins similar to those with respect to shuttle 40 and chill plate 30. Also, in one embodiment bake plate 22 includes a plurality of vacuum ports and can be operatively coupled to a vacuum chuck to secure a wafer to the bake plate during the baking process.

During the baking process, a faceplate 422 is positioned just above and opposite the upper surface of bake plate 22. Faceplate 422 can be made from aluminum as well as other suitable materials and includes a plurality of holes or channels 422a that allow gases and contaminants baked off the surface of a wafer being baked on bake plate 22 to drift through faceplate 422 and into a radially inward gas flow 424 that is created between faceplate 422 and top heat plate 410.

Gas from radially inward gas flow 424 is initially introduced into bake station 20 at an annular gas manifold 426 that encircles the outer portion of top heat plate 410 by a gas inlet line 427. Gas manifold 426 includes numerous small gas inlets 430 (128 inlets in one embodiment) that allow gas to flow from manifold 426 into the cavity 432 between the lower surface of top heat plate 410 and the upper surface of faceplate 422. The gas flows radially inward towards the center of the station through a diffusion plate 434 that includes a plurality of gas outlet holes 436. After flowing through diffusion plate 434, gas exits bake station 20 through gas outlet line 428.

Bake plate 22 heats a wafer substrate 60 according to a particular thermal recipe. One component of the thermal recipe is typically a set point temperature at which the bake plate is set to heat the wafer substrate. During the baking process, the temperature of the wafer support is routinely measured and one or more zones of the bake plate can be adjusted to ensure uniform heating of the substrate. In many embodiments, bake plate 22 is heated to the desired set point temperature while a large batch of wafers are processed according to the same thermal recipe. Thus, for example, if a particular thermal recipe calls for a set point temperature of 175° C. and that recipe is to be implemented on 100 consecutive wafers, bake plate 22 will be heated to 175° C. during the period of time it takes to process the 100 consecutive wafers.

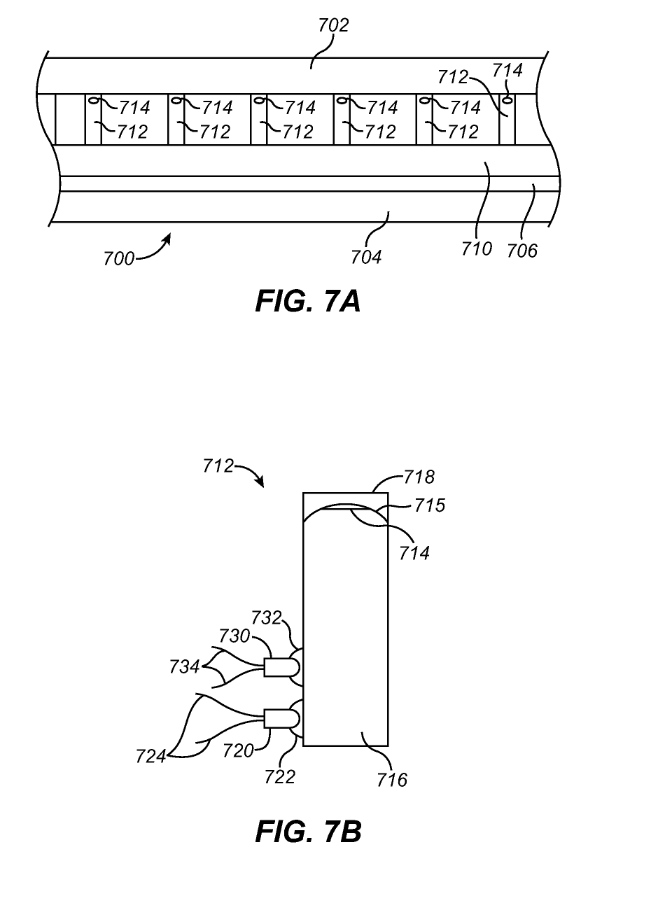

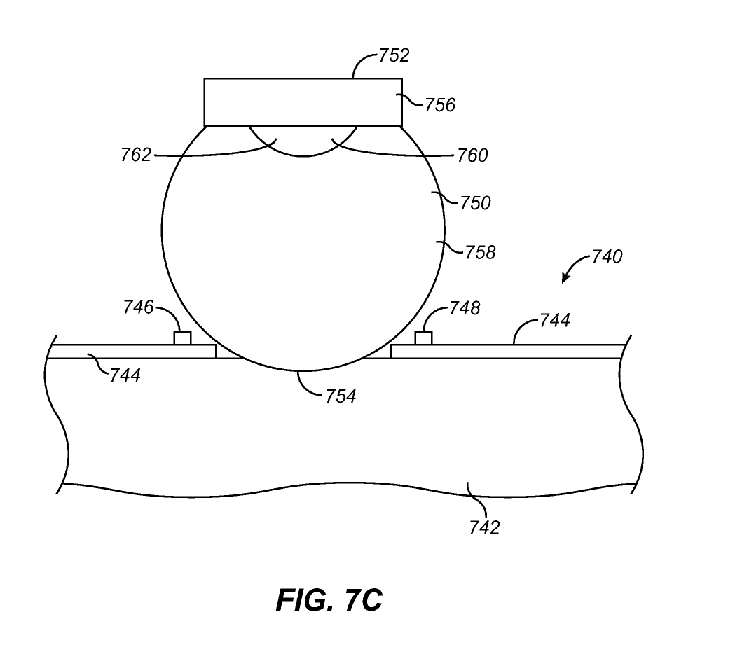

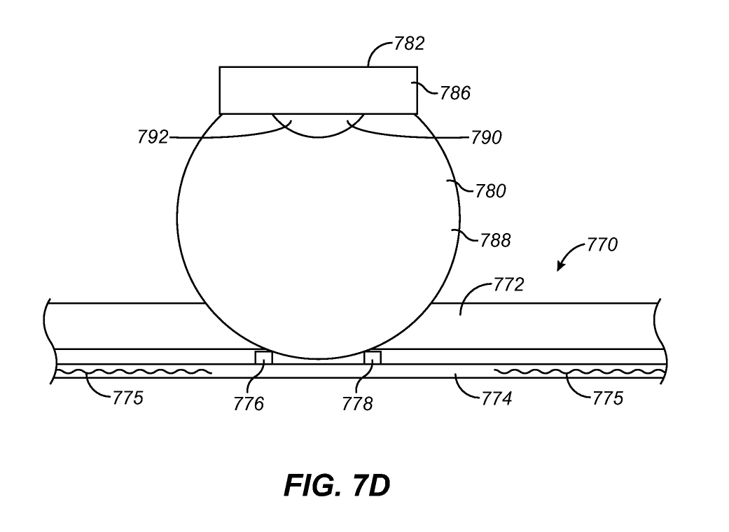

FIG. 7A shows a simplified cross sectional view of a bake plate 700 comprising a substrate support layer and several temperature sensing proximity pins that support a semiconductor wafer, according to embodiments of the present invention. Bake plate 704 comprises a heating element layer 706 and a support layer 710. Support layer 710 contacts proximity pins 712 to support a semiconductor wafer 702. A photoluminescent material 714 is positioned near the upper end of proximity pins 712 such that the photoluminescent material responds to the temperature of the wafer.

FIG. 7B shows temperature sensing proximity pins as in FIG. 7A in greater detail, according to embodiments of the present invention. Proximity pins 712 comprise photoluminescent temperature sensors. Proximity pins 712 comprise an upper end 718 and a lower end 716. A photoluminescent material 714 can be positioned near upper end 718 to measure a temperature of wafer 702. Photoluminescent material 714 emits an optical signal, for example a fluorescence signal and/or a phosphorescence signal in response to the temperature of the wafer. Photoluminescent material 714 can be positioned in a structure that contacts the wafer such that heat is conducted from the wafer to the structure and the photoluminescent material emits a signal in response to the temperature of the wafer. An excitation light source 720 is optically coupled to photoluminescent material 714 to excite the photoluminescent material. Photoluminescent material 714 emits a fluorescence signal and/or a phosphorescence signal in response to the excitation light energy and the temperature of the wafer. A photoluminescence detector 730 is optically coupled to photoluminescent material 714 to measure the photoluminescence of the material, for example a fluorescence and/or a phosphorescence decay time.

Excitation light source 720 may comprise many know light sources. For example, excitation light source 720 may comprise a light emitting diode, LED, a laser diode, a gas laser, a solid state laser, a Q-switched laser, flash lamp and/or stroboscopic lamp. Excitation light source 720 may comprise wires 724 that provide electrical energy to the light source to emit excitation light energy.

In many embodiments, the light source and detector are optically coupled to the photoluminescent material. Excitation light source 720 can be connected to proximity pin 712 with optically transparent glue, cement or the like to hold the excitation light source in place and optically couple the light source to photoluminescent material 714. An optically transparent glue, cement or the like can be used to hold the detector in place and optically couple the detector to the photoluminescent material. In many embodiments, proximity pins 712 comprise an optically transparent material that transmits the excitation light energy from the excitation light source to the photoluminescent material and transmits the photoluminescent light energy from the photoluminescent material to the photoluminescent detector. The optically transparent material may comprise many known optically transmissive materials including ceramics, fused silica, crown glass, glass, magnesium fluoride, and/or sapphire and calcium fluoride.

Photoluminescent detector 730 may comprise many known light energy detectors. Photoluminescence detector 730 may comprise a photo diode, a phototransistor, an avalanche photodiode and/or a photomultiplier tube. In many embodiments, a decay time of the photoluminescent signal measured with the detector can be used to determine the temperature of the material. Photoluminescence detector 730 may comprise wires that transmit an electrical signal in response to the photoluminescent light energy transmitted from the photoluminescent material to the detector.

The photoluminescent material can be positioned near the upper end of the proximity pin in many ways. For example, photoluminescent material 714 can be positioned within proximity pins 712, and proximity pins 712 may comprise hollowed out portions, or cavities, to retain the photoluminescent material. Proximity pins 712 may comprise cylindrical shapes, spherical shapes, and may comprise spherical balls and/or cylindrical rods, according to embodiments. A lower portion of the pin can be formed with a spherical upper end 715 that is fit to a radius. The convex spherical upper end of the lower portion of the proximity pin can be ground flat and the photoluminescent material positioned near the flat portion. A concave upper portion of the proximity pin can be positioned over the lower portion and photoluminescent material. The upper and lower portions may have matching radii of curvature to provide a good fit between the upper and lower portions with the photoluminescent material retained between the upper and lower portions. In specific embodiments, the photoluminescent material may comprise a ceramic powder. In many embodiments, the upper and lower portion can be joined with diffusion bonding.

FIG. 7C shows a bake plate 740 comprising a spherical temperature sensing proximity pin 750, according to embodiments of the present invention. Spherical temperature sensing proximity pin 750 may comprise an upper end 752 and a lower end 754. Upper end 752 is adapted to contact a semiconductor wafer as described above. Lower end 754 is adapted to contact a support layer 742 of a bake plate 740 as described above. An upper portion 756 of proximity pin 750 comprises a cap. A lower portion 758 of proximity pin 750 comprises a spherical ball with a cavity 762, or hollowed out portion. A photoluminescent material 760 is retained in cavity 762. Bake plate 740 comprises a printed circuit board 744, or PCB, that can be fabricated in many known ways. For example, printed circuit board 744 can be fabricated with flexible polyimide film sold under the trademark Kapton® from DuPont Electronics so as to make a flexible PCB. In some embodiments, the PCB may be rigid. Printed circuit board 774 comprises an excitation light source 746, as described above, that is positioned near the bottom end of the proximity pin and optically coupled to the photoluminescent material. Printed circuit board 774 comprises a photoluminescence detector 748 that is positioned near the bottom end of the proximity pin and optically coupled to the photoluminescent material. The light source and detector can be mounted to the printed circuit board. Printed circuit board 774 may comprise a heating element to heat the wafer.

FIG. 7D shows a bake plate 770 comprising a temperature sensing proximity pin 780 that passes at least partially through an opening formed in the support layer, according to embodiments of the present invention. Temperature sensing proximity pin 780 may be spherical and comprise an upper end 782 and a lower end 784. Upper end 782 is adapted to contact a semiconductor wafer as described above. Lower end 784 is adapted to pass through an opening formed in a support layer 772 of bake plate 770. An upper portion 786 of proximity pin 780 comprises a cap. A lower portion 788 of proximity pin 780 comprises a spherical ball with a cavity 792, or hollowed out portion. A photoluminescent material 790 is positioned in cavity 792. Bake plate 770 comprises a printed circuit board 774. Printed circuit board 774 comprises an excitation light source 776, as described above, that is positioned near the bottom end of the proximity pin and optically coupled to the photoluminescent material. Printed circuit board 774 comprises a photoluminescence detector 778 that is positioned near the bottom end of the proximity pin and optically coupled to the photoluminescent material. Printed circuit board 774 may comprise a heating element 775 to heat the bake plate and the wafer. In many embodiments, support layer 772 comprises a heat conducting metal, for example aluminum. Support layer 772 can be positioned between heating element 775 and the wafer such that support layer 772 spreads heat from the heating element to provide uniform heat to the wafer.

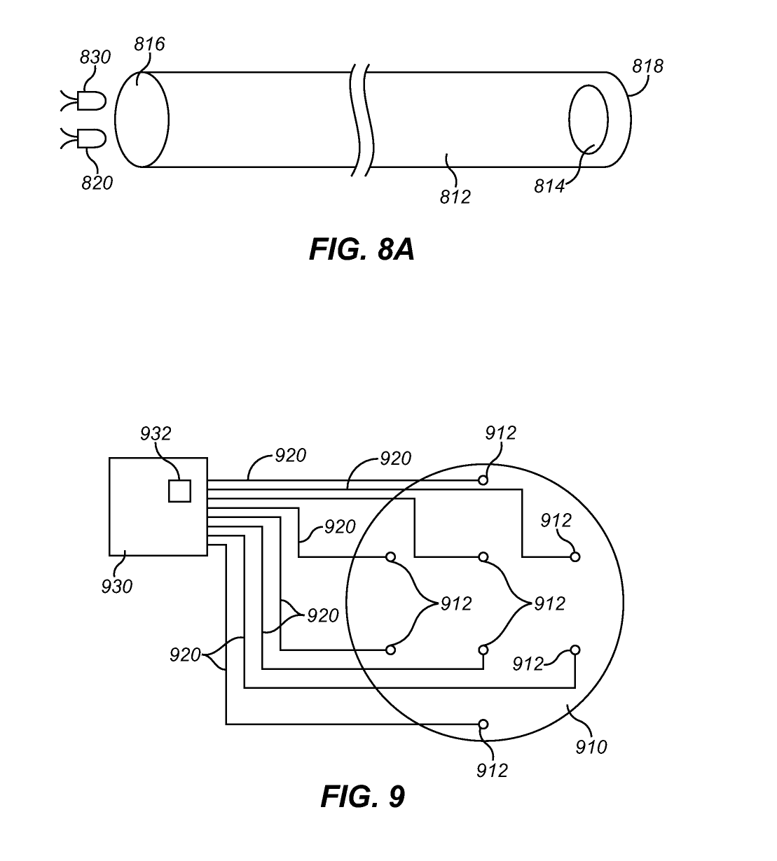

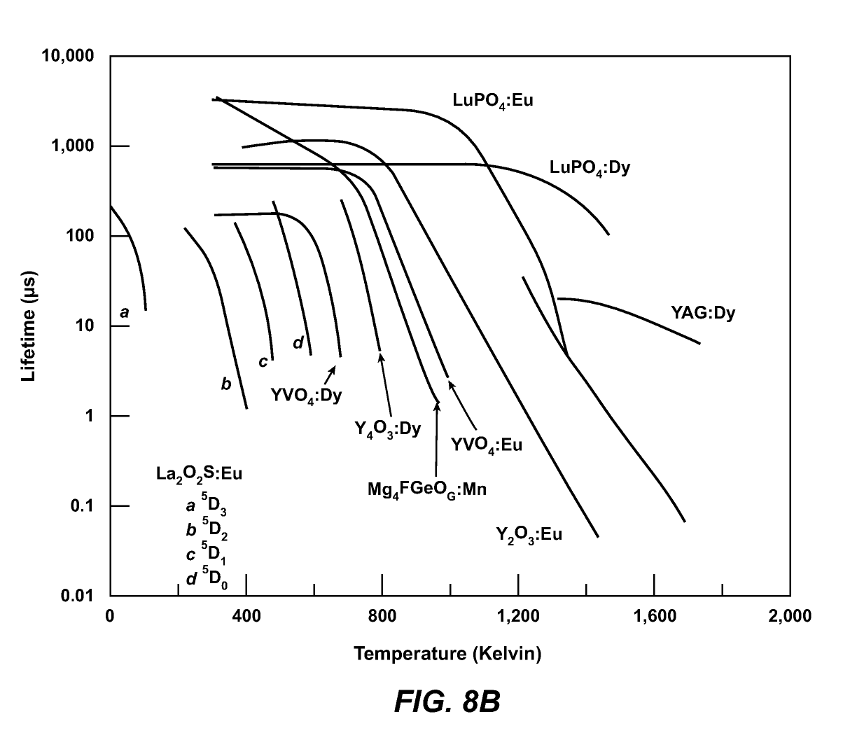

FIG. 8A shows a waveguide 812 that can be used to position a photoluminescent material 814 near a wafer to measure the temperature of the wafer, according to embodiments of the present invention. A distal end 818 of waveguide 812 can be positioned near the wafer. In many embodiments, the distal end of the waveguide contacts the wafer such that heat is conducted directly from the wafer to the waveguide. The photoluminescent material is retained near the distal end of the waveguide to emit a photoluminescent light energy signal in response to the temperature of the photoluminescent material while the distal end contacts the wafer. An excitation light source 820 is optically coupled to photoluminescent material 814 at a proximal end 816 of the waveguide. A photoluminescent detector 830 is optically coupled to photoluminescent material 814 at proximal end 816 of the waveguide. Waveguide 812 may comprise an optical fiber and/or elongate rod that transmits light internally with internal reflection. Several waveguides with several distal ends may be placed in contact with the wafer at several locations on the wafer to measure the temperature of the wafer at the several locations.

FIG. 8B shows lifetimes of photoluminescent materials that comprise phosphorescent materials, according to embodiments of the present invention. In many embodiments, the phosphorescent material comprises at least one of La₂O₂S:Eu, YVO₄:Dy, Y₂O₃:Dy, Mg₄FGeO₆:Mn, YVO₄:Eu, Y₂O₃:Eu, LuPO₄:Eu, LuPO₄:Dy, YAG:Dy. Several lifetimes, or decay times, are shown for several excited states of La₂O₂S:Eu, for example ⁵D₃, ⁵D₂, ⁵D₁ and ⁵D₀. In many embodiments, the lifetime is at least one microsecond, such that the excitation light source can be turned on to excite the material, and the lifetime then measured while the excitation light source is turned off. In some embodiments, optical filters such as interference filters, gratings, prisms and/or polarizers may be used to separate the emission light energy form the photoluminescent light energy in response to the wavelength of light.

In some embodiments, methods and systems suitable for measuring lifetimes associated with the excitation of the photoluminescent materials are employed. For example, the excitation light source may be operated in a pulsed manner and detection of the light emission from the photoluminescent material may then be performed using a lock-in amplifier. For excitation sources that are able to be modulated to generate a pulse train, for example, semiconductor lasers, direct modulation of the source may be utilized. For other CW sources, optical elements such as amplitude modulators may be used to generate a pulse train. One of ordinary skill in the art would recognize many variations, modifications, and alternatives.

In many embodiments, the photoluminescent material may comprise a fluorescent material. Suitable fluorescent materials include YAG:Ce:Ga, YAG:CR, and/or YAG:Cr:Yb crystal. In many embodiments, a decay time of the fluorescent light energy is measured to determine the temperature of the wafer.

FIG. 9 shows a bake plate 910 comprising several temperature sensing proximity pins 912 to map the temperature of the wafer, according to embodiments of the present invention. Proximity pins 912 can sense the temperature of the wafer while the wafer is positioned on the proximity pins. Proximity pins 912 may comprise proximity pins with a photoluminescent material as described above. Proximity pins 912 can be coupled to a controller 930 with lines 920 to determine the temperature of the wafer at each proximity pin location. Controller 930 comprises a timer 932 to time the decay of the photoluminescent light energy emitted from the photoluminescent material in the proximity pins at each location.

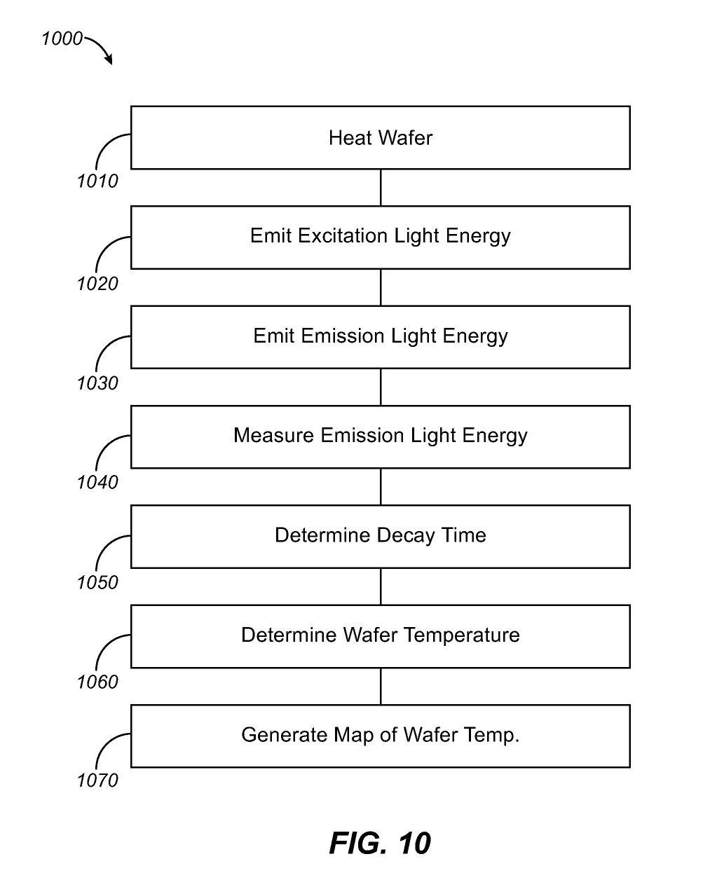

FIG. 10 shows a method 1000 of measuring a temperature of a semiconductor wafer, according to embodiments of the present invention. A step 1010 heats the wafer, for example with a bake plate as described above. A step 1020 emits and an excitation light energy that induces an excited state in a photoluminescent material. A step 1030 emits an emission light energy from the photoluminescent material. The emission light energy may comprise a decay time related to the temperature of the wafer. A step 1040 measures an emission light energy with a detector to generate an emission light energy signal. A step 1050 determines a decay time of the emission light energy from the photoluminescent material. A step 1060 determines a temperature of the wafer from the decay time of the photoluminescent material. A step 1070 generates a map of wafer temperature at several locations on the wafer.

It should be appreciated that the specific steps illustrated in FIG. 10 provide a particular method of measuring a temperature of a semiconductor wafer, according to an embodiment of the present invention. Other sequences of steps may also be performed according to alternative embodiments. For example, alternative embodiments of the present invention may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize many variations, modifications, and alternatives.

While the exemplary embodiments have been described in some detail for clarity of understanding and by way of example, a variety of additional modifications, adaptations, and changes may be clear to those of skill in the art. Hence, the scope of the present invention is limited solely by the appended claims, along with the full scope of their equivalents.

What is claimed is:

1. An apparatus for measuring a temperature of a semiconductor wafer, the apparatus comprising:
a structure to support the semiconductor wafer, the structure comprising an upper end and a lower end, the upper end of the structure adapted to contact the wafer;
a photoluminescent material adapted to emit an emission light energy in response to the temperature of the wafer;
a light source to emit an excitation light energy, the light source optically coupled to the photoluminescent material; and
a detector adapted to measure the emission light energy emitted from the photoluminescent material to determine the temperature of the wafer while the wafer is supported by the structure.

2. The apparatus of claim 1 wherein the photoluminescent material is positioned near the upper end of the structure to measure the temperature of the wafer.

3. The apparatus of claim 1 wherein the structure comprises a proximity pin.

4. The apparatus of claim 1 wherein the structure comprises a temperature sensor with the photoluminescent material near the upper end.

5. The apparatus of claim 1 wherein the structure comprises an optically transparent material.

6. The apparatus of claim 1 wherein the light source and the detector are positioned near the lower end of the structure and optically coupled to the photoluminescent material.

7. The device of claim 1 wherein the structure comprises a waveguide to transmit the excitation light energy from the light source to the material and transmit the emission light energy from the material to the detector.

8. The apparatus of claim 1 further comprising a timer to measure a decay time of the emission light energy.

9. The apparatus of claim 1 further comprising a processor to determine the temperature of the wafer in response to a signal from the detector.

10. The apparatus of claim 1 wherein the photoluminescent material comprises at least one of a phosphorescent material or a fluorescent material.

11. The apparatus of claim 1 wherein the material comprises at least one of La₂O₂S:Eu, YVO₄:Dy, Y₂O₃:Dy, Mg₄FGeO₆;Mn YVO₄:Eu, Y₂O₃:Eu, LuPO₄:Eu, LuPO₄:Dy, YAG:Dy.

12. A bake plate for processing a semiconductor wafer, the bake plate comprising:
a heating element adapted to heat the wafer to establish a wafer temperature;
a light source adapted to emit an excitation light energy;
a photoluminescent material adapted to absorb the excitation light energy and emit an emission light energy in response to the wafer temperature; and
a detector adapted to measure the emission light energy from the photoluminescent material to determine the temperature of the wafer.

13. The bake plate of claim 12 further comprising a structure adapted to support the wafer, wherein an upper portion of the structure is adapted to contact the wafer and a lower portion of the structure is adapted to contact a support layer.

14. The bake plate of claim 13 wherein the structure comprises an optically transmissive material that extends through the support layer to transmit the emission light energy from the photoluminescent material to the detector.

15. The bake plate of claim 12 further comprising a printed circuit board having the light source and the detector mounted thereon.

16. The bake plate of claim 12 further comprising a support layer and a printed circuit board, wherein the printed circuit board comprises the light source, the heating element and the detector and wherein the support layer is positioned between the printed circuit board and the wafer.

17. A method of measuring a temperature of a semiconductor wafer, the method comprising:
contacting the wafer with a structure to conduct heat from the wafer to the structure, wherein the structure comprises a photoluminescent material that emits an emission light energy in response to the temperature of the wafer; and
measuring the emission light energy with a detector to determine a temperature of the wafer.

18. The method of claim 17 wherein the temperature of the wafer is determined with a lifetime of the emission light energy.

19. The method of claim 17 further comprising mapping the temperature of the wafer at several locations of the wafer.

20. The method of claim 17 wherein wafer is heated with a bake plate and the temperature of the wafer is measured in response to heat from the bake plate.
